(19) United States
(12) Patent Application Publication
(10) Pub. No.: US 2012/0217225 A1
(43) Pub. Date: Aug. 30, 2012

(54) SPARK GAP CONTROL FOR ELECTRO-DISCHARGE MACHINING

(76) Inventors: Mervyn Rudgley, Mission Viejo, CA (US); Kenneth Gold, Bell Canyon, CA (US); Michael Gibbons, Costa Mesa, CA (US); James Legge, Rancho Palos Verdes, CA (US); Richard Gerlach, Huntington Beach, CA (US)

(21) Appl. No.: 13/505,664

(22) PCT Filed: Oct. 21, 2010
(86) PCT No.: PCT/US2010/053587

§ 371 Date: May 2, 2012

Related U.S. Application Data
(60) Provisional application No. 61/253,819, filed on Oct. 21, 2009.

(51) Int. Cl. B23H 1/00

(52) U.S. Cl. 219/69.16

(57) ABSTRACT

A control module for an EDM device, comprises: controls for managing power supplied to the EDM device, taking voltage measurements, calculating responses, and controlling advancement of an electrode of the EDM device. The EDM device may include a piezoelectric crystal that electrically in parallel with the voltage applied to a spark gap between the electrode and a workpiece.

### RELATED APPLICATION

This application claims the full Paris Convention Priority from, and is a U.S. National Stage entry of PCT/US2010/053587 filed Oct. 21, 2010; which is based upon U.S. Provisional Patent Application Ser. No. 61/253,819, filed Oct. 21, 2009, the contents of which is incorporated by reference herein in its entirety, as if fully set forth herein.

### BACKGROUND

1. Field

This disclosure relates to control devices and methods for an EDM device and processes.

2. General Background

Electric discharge machining, or EDM, is an established method and apparatus utilized for machining metal. It operates through the utilization of an electrical discharge to remove metal from the workpiece. In the EDM process, an electrode is brought into close proximity to the workpiece. High voltage is applied in pulses at high frequency. The process occurs in the presence of a dielectric fluid. This creates sparking at generally the closest position between the workpiece and the electrode. Particles are removed from the workpiece when sparking is quenched. The duration of the spark (on-time or active state) and the recovery time (off-time or inactive state) are controlled so that the workpiece and electrode temperatures are not raised to the temperature of bulk melting. Therefore, erosion is essentially limited to a vaporization process.

Control of a spark gap is at least in part defined by the distance and space between an erosion electrode and a target. If the spark gap is too large, the plasma event may not occur. If the spark gap is too small, the plasma event may be insufficient to remove desired amounts of material. If the erosion electrode contacts the workpiece, then no plasma event may occur until a spark gap is restored.

### SUMMARY

According to some exemplary implementations, disclosed is a control module, comprising: a switch control configured to selectively open and close a switch connecting a power source to an erosion electrode of an EDM device; a voltage sensor configured to sense a voltage in a spark gap; a CPU configured to calculate a response command based on the voltage sensed in the spark gap; and a motor control configured to cause a motor of the EDM device to selectively control the position of the erosion electrode according to the response command.

The response command causes the spark gap to narrow, widen, or remain the same. The response command may be calculated based on a plurality of sensed voltage readings in the spark gap. The motor may be configured to controllably position the erosion electrode relative to the workpiece. The control module may be connected to the EDM device via an umbilical.

According to some exemplary implementations, disclosed is an EDM device, comprising: a base; a driver housing; a motor configured to controllably position the driver housing relative to the base; an erosion electrode connected to the driver housing by a piezoelectric crystal disposed between the erosion electrode and the driver housing; wherein the EDM device is electrically connected to a power source configured to selectively provide a voltage across a spark gap; wherein the piezoelectric crystal is electrically connected to the power source in parallel with the spark gap and is configured to advance or retract the erosion electrode in response to the voltage from the power source.

The piezoelectric crystal may be configured to advance the erosion electrode toward the workpiece in response to an increase in the voltage from the power source. The piezoelectric crystal may be configured to retract the erosion electrode away from the workpiece in response to a drop in the voltage from the power source. The motor may be configured to selectively control the spark gap according to a response command based on a voltage sensed in the spark gap. The EDM device may be a hand-held unit. The EDM device may be connected to a control module via an umbilical.

The control module may comprise: a switch control configured to selectively open and close a switch connecting the power source to the erosion electrode of the EDM device; a voltage sensor configured to sense the voltage in the spark gap; a CPU configured to calculate a response command based on the voltage sensed in the spark gap; and a motor control configured to cause the motor of the EDM device to selectively control the position of the erosion electrode according to the response command.

According to some exemplary implementations, disclosed is a method for controlling a spark gap, comprising: measuring a voltage sample across a spark gap; correlating the measured voltage sample with one of: an open state, a plasma state, and a short state of the spark gap; assigning a weight parameter to the voltage sample, wherein each of the open state, the plasma state, and the short state have a unique weight parameter; determining a response command based on the weight parameter; causing a motor to control the spark gap based on the response command.

A weight parameter of the open state corresponds to a response command to widen the spark gap. A weight parameter of the plasma state corresponds to a response command to substantially maintain the spark gap. A weight parameter of the short state corresponds to a response command to narrow the spark gap.

The plasma state occurs within one of a plurality of plasma voltage ranges. The plurality of plasma voltage ranges may be contiguous. Each of the plurality of plasma voltage ranges corresponds to a distinct weight parameter. The plurality of plasma voltage ranges may comprise: a high-voltage weak plasma, a strong plasma, and a low-voltage weak plasma. The voltage sample includes a plurality of measured voltages across the spark gap.

Determining a response command may comprise: eliminating measured voltages that correspond to measurements taken during an inactive period of a duty cycle to determine remaining parameters; calculating a combination parameter as the average value of the remaining parameters, wherein the combination parameter corresponds to a response command; and causing a motor to control the spark gap based on the response command.

According to some exemplary implementations, disclosed is a method for controlling a spark gap, comprising: measuring a plurality of voltages across a spark gap, wherein the voltages are provided by a power source having a duty cycle with an active period and an inactive period; assigning a weight parameter to each of the plurality of measured voltages; calculating a combination parameter based on the measured plurality of voltages, wherein the combination parameter corresponds to a response command; and causing a motor to control the spark gap based on the response command.

Causing the motor to control the spark gap results in an increased rate of plasma events. The weight parameter corresponds to one of: an open state, at least one plasma state, and a short state of the spark gap, each state having a corresponding weight parameter. The combination parameter may be an average value of the weight parameters. The plurality of voltages may be only measured during the active period of the duty cycle.

Calculating a combination parameter may comprise: eliminating weight parameters that correspond to voltages measured during the inactive period of the duty cycle, wherein the combination parameter is an average value of the parameters remaining after the eliminating step. Measuring a plurality of voltages may be done at an interval having a measurement period not exceeding a pulse period of the duty cycle.

### DRAWINGS

The above-mentioned features and objects of the present disclosure will become more apparent with reference to the following description taken in conjunction with the accompanying drawings wherein like reference numerals denote like elements and in which:

FIG. 1 shows a view of a workman applying a hand-held EDM device to a workpiece;

FIG. 2 shows a block diagram of an EDM device and control components, according to exemplary implementations;

FIG. 3A shows an exemplary implementation of a graph of ranges for voltage readings and corresponding weight parameters;

FIG. 3B shows an exemplary implementation of a graph of ranges for voltage readings and corresponding weight parameters;

FIG. 4A shows an operational flow chart of a spark gap control method;

FIG. 4B shows an operational flow chart of a spark gap control method;

FIG. 4C shows an operational flow chart of a spark gap control method;

FIG. 5A shows a schematic view of an EDM device and power source;

FIG. 5B shows a schematic view of an EDM device with a piezoelectric crystal and power source;

FIG. 6 shows a schematic view of an EDM device with a piezoelectric crystal;

FIG. 7 shows a graphical representation of data collected during a process performed with a traditional controller;

FIG. 8 shows a graphical representation of data collected during a process performed with a direct-coupled piezo-activated configuration; and

FIG. 9 shows a graphical representation of data collected during a process performed with a novel measurement and response system.

### DETAILED DESCRIPTION

As used herein, “spark gap” means the space defining the shortest distance between erosion electrode 66 and the workpiece.

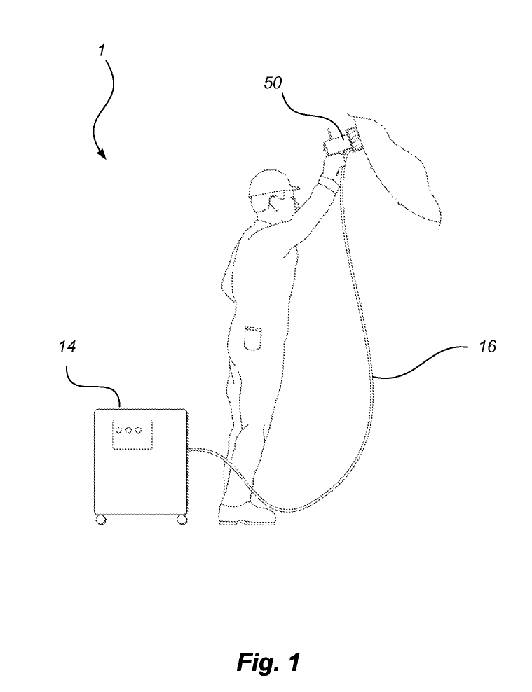

According to some exemplary implementations, EDM device 50 may be configured to erode at least a portion of a workpiece by electrical discharge machining (“EDM”). EDM device 50 may be part of EDM system 1, including support and control components. EDM device 50 may be part of an integrated workstation, including support unit 14. As shown in FIG. 1, EDM device 50 may be hand-held by a user, according to some exemplary implementations. For example, EDM device 50 may be part of EDM system 1 which supplies power, control and dielectric fluid (which may also be a coolant) via support unit 14. Flexible umbilical 16 interconnects EDM device 50 and support unit 14 so that the hand-held device can be positioned as desired.

According to some exemplary implementations, EDM device 50 may be positioned to remove a fastener that extends through one or more frames. Further disclosure of configurations and uses of EDM devices are provided in U.S. Patent Publication No. 2010/0096365, published Apr. 22, 2010; WIPO Publication No. WO 2010/048339, published Apr. 29, 2010; and U.S. Pat. No. 6,225,589, issued on May 1, 2001, the entirety of which are incorporated by reference, as if fully set forth herein. Erosion electrode 66 of EDM device 50 may be provided near the workpiece, and a charge applied thereto. A spark gap, defined as a space between erosion electrode 66 and the workpiece, may be maintained. Ground electrode 62 may be placed in contact and electrical conduction with the workpiece. Alternatively, ground electrode 62 may be or may be a part of a surface upon which a workpiece rests or to which it is affixed. A dielectric fluid may be provided in the spark gap. As the charge is applied, a breakdown in the dielectric fluid may occur and a plasma event may follow, in which electrical charge is passed across the spark gap through the vaporized dielectric fluid, whereby at least a portion of the workpiece is eroded and removed. The flow of the dielectric fluid may remove the eroded portion from the spark gap and maintain the nearby components at or near a given temperature.

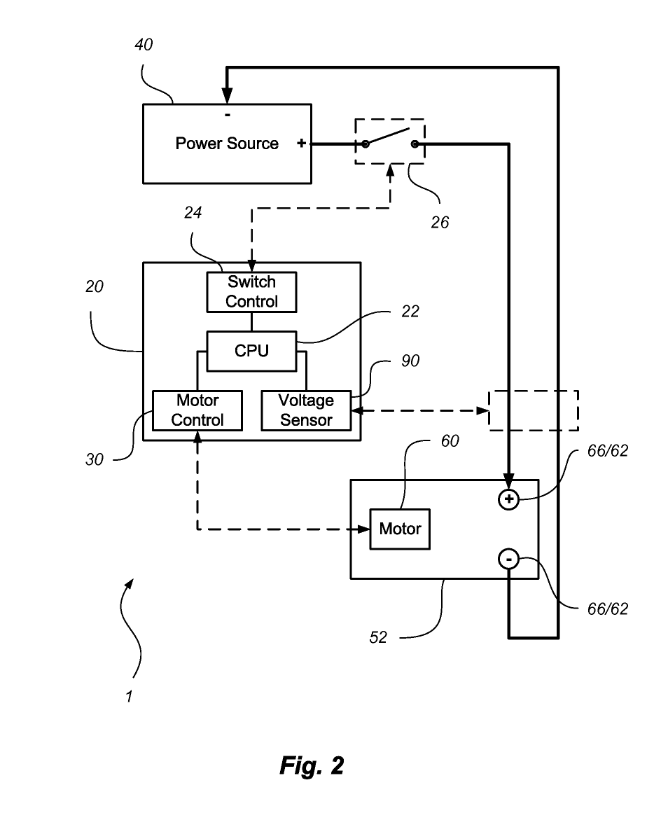

According to some exemplary implementations, as shown in FIG. 2, control module 20 includes CPU 22, switch control 24, motor control 30, and voltage sensor 90. Control module 20 may be onboard device 50 or support unit 14.

According to some exemplary implementations, CPU 22 is configured manage and control components of control module 20 and other systems as well as collect, compile, analyze, or calculate data within control module 20. CPU 22 may operate according to provided programming or operation by a user.

According to some exemplary implementations, switch control 24 is configured to selectively operate switch 26 connecting power source 40 with at least one electrode of the EDM device. The operation of switch 26 may be in accordance with a programmed duty cycle. For example, the operation of switch control 24 may determine the duty cycle of a DC current to the electrodes of the EDM device. By further example, a duty cycle may be provided by other mechanisms, and switch 26 may operate to manage other aspects of the EDM device while in operation.

According to some exemplary implementations, voltage sensor 90 is configured to sense, measure, or record a voltage difference across two electrodes (i.e., erosion electrode 66 and ground electrode 62) of the EDM device. This voltage difference is representative of the voltage applied at the spark gap. Thus, the occurrence of a plasma event, a short, or an open circuit may be inferred from the operation of voltage sensor 90. Voltage sensor 90 may further determine a voltage difference from any two points, each being in electrical conduction with one of the two sides of the spark gap. Other configurations and mechanisms for determining voltage directly or indirectly may be employed, as shall be appreciated by those having ordinary skill in the art.

According to some exemplary implementations, motor control 30 is configured to control motor 60 of the EDM device. For example, the size of the spark gap may be maintained or modified by motor 60 based on operation of the control module, as disclosed further herein.

According to some exemplary implementations, motor control 30 effectuates the advancement and retraction of erosion electrode 66 relative to base 52 of EDM device 50. Base 52 presented is preferably a portion of a handheld EDM device supporting at least erosion electrode 66, ground electrode 62, and components for controllably providing dielectric fluid (which may act as coolant) or at least a hand held portion of a hand held EDM system.

According to some exemplary implementations, motor 60 manages the position of at least one of erosion electrode 66 and electrode driver housing 58 relative to at least one of base 52 and the target/workpiece. For example, motor 60 may be a linear motor or any motor adapted to effect linear motion. For example, a stepper motor may be used for motor 60. Other motors and combinations of motors may be provided to achieve lateral motion or provide other action to erosion electrode 66. When EDM device 50 is provided to a workpiece, the position of erosion electrode 66 relative to base 52 may correspond to the position of erosion electrode 66 to the workpiece.

An electrical pulse provided to erosion electrode 66 may result in a voltage differential across the spark gap. Depending on conditions in the spark gap, the pulse may have one of at least three results.

First, there may be no breakdown of the dielectric fluid due to insufficient voltage to overcome the insulating properties of the dielectric fluid. This is considered an “open” circuit in which no electrons flow because no plasma event occurs. As used herein, an “open state” of the spark gap means a state in which the conditions in the spark gap are insufficient to cause both (1) dielectric breakdown and (2) voltage release by current across the spark gap. In an open state, no plasma event occurs.

Second, there may be a flow of electrons directly from erosion electrode 66 to the workpiece due to a “short” cause by direct contact between erosion electrode 66 and the workpiece. This flow may bypass the dielectric fluid; thus no dielectric breakdown or plasma event occurs. As used herein, a “short state” of the spark gap means a state in which the conditions in the spark gap are insufficient to cause dielectric breakdown, yet in which the voltage is released by current from erosion electrode 66 to the workpiece. In a short state, no plasma event occurs.

Third, the voltage may be sufficiently high to overcome the insulating properties of the dielectric fluid, resulting in breakdown thereof during a plasma event in the spark gap. Because erosion occurs during plasma events, an EDM device operates efficiently when plasma events occur more frequently. As used herein, a “plasma state” of the spark gap means a state in which the conditions in the spark gap are sufficient to cause both (1) dielectric breakdown and (2) voltage release by current across the spark gap. In a plasma state, a plasma event occurs.

According to some exemplary implementations, motor 60 may, at least in part, be used to adjust the size of the spark gap during an erosion process based on measurements taken during the erosion process. For example, the voltage at which a plasma event may occur (during which the dielectric fluid “breaks down”) may be expressed as Equation 1:

V_{G}=E_{DS}*D (Eq. 1)

“V_{G}” is the voltage in the spark gap, “E_{DS}” is the dielectric strength of the dielectric fluid (i.e., the maximum electric field strength that it can withstand without breaking down), and “D” is the distance between erosion electrode 66 and the workpiece (i.e., the size of the spark gap).

Dielectric strength of the dielectric fluid may be known based on the known characteristics of the chosen dielectric fluid. Furthermore, the voltage leading up to and during a plasma event may be measured during the process. Thus, the distance of the spark gap may be expressed as Equation 2:

D=V_{G}/E_{DS} (Eq. 2)

V_{G} may not be measured directly, due to conditions in the spark gap (e.g., the small size of the spark gap). Rather, the voltage in the spark gap may be inferred from measurements taken on the far side of the anode and cathode electrodes (i.e., erosion electrode 66 and ground electrode 62) from the spark gap, as shown in FIG. 2. Voltage drops at the anode and cathode may be considered to provide an accurate calculation of V_{G}, which may be expressed as Equation 3:

V_{G}=V_{M}−V_{A}−V_{C} (Eq. 3)

“V_{M}” is the voltage measured by the voltage sensor, “V_{A}” is the voltage drop in the gap near the vicinity of the anode (generally constant and determinable based on electrode materials and dielectric characteristics), and “V_{C}” is the voltage drop in the gap near the vicinity of the cathode (generally constant and determinable based on electrode materials and dielectric characteristics).

Thus, Equation 2 may be expressed as Equation 4:

D=(V_{M}−V_{A}−V_{C})/E_{DS} (Eq. 4)

Based on this calculation, the distance of the spark gap may be determined and appropriate corrections may be taken during the process to maintain a distance that is within a preferred range. Where the distance is maintained in the preferred range, the number of pulses that result in plasma events may be increased.

Spark Gap Control with a Traditional Device

Some negative feedback control systems are currently provided for general applications. For example, Servo control mechanisms, such as those provided by Galil Motion Control, Inc.® (Rocklin, Calif.), provide motion control based on readings taken during a process. However, such systems for general applications do not adequately address an EDM device according to some exemplary embodiments of the present disclosure.

For example, certain servomechanisms tested performed voltage readings on a recurring period that was greater than the period of the pulse wave provided by power source 40 to erosion electrode 66. For example, readings were taken at intervals ranging between about 1.2 milliseconds to 10 milliseconds for pulses provided every 800 microseconds. Because the reading interval is greater than the period for pulses, the servomechanism was unable to take readings for every pulse.

Further, certain servomechanisms failed to account for occasions in which no pulse was provided. For example, for a 90% duty cycle (i.e., 90% active state), voltage readings were taken in the duration of time in which no pulse is provided (i.e., the 10% inactive state). Thus, several voltage readings were taken during times in which plasma events were not achievable due to the inactive state of the duty cycle. Any actions taken on such readings were based on the improper premise that the readings truly represented conditions during an active state of the duty cycle.

Further, certain servomechanisms were limited to analysis of the readings based on a single threshold. For example, the voltage read was compared to a target voltage. If the reading was higher than the target, advancement in one direction was effected. If the reading was lower than the target, advancement in the opposite direction was effected. No reading and response of the servomechanism would result in maintenance of the electrode position. This was problematic whenever at least substantially maintaining the electrode was more effective than advancement or retraction thereof. Further, only one of two advancement options were presented, rather than a broader variety based on the magnitude of measurements taken. Thus, no consideration was given to the magnitude of deviation from the target threshold.

Spark Gap Control with a Novel Measurement and Response System

According to some exemplary implementations, a novel measurement and response system and method are disclosed herein. The novel measurement and response system and method provide more efficient performance results for EDM devices according to the present disclosure. According to some exemplary implementations, methods of measuring and responding to conditions in the spark gap are disclosed.

According to some exemplary implementations, voltage sensor 90 of control module 20 may take voltage measurements in measurement periods less than or substantially less than a pulse period. For example, measurements may be taken every 40 microseconds. For a pulse wave having a period of about 800 microseconds, this provides for about 20 measurements in a single pulse period. This enables the system to make any adjustments desired in response to every pulse.

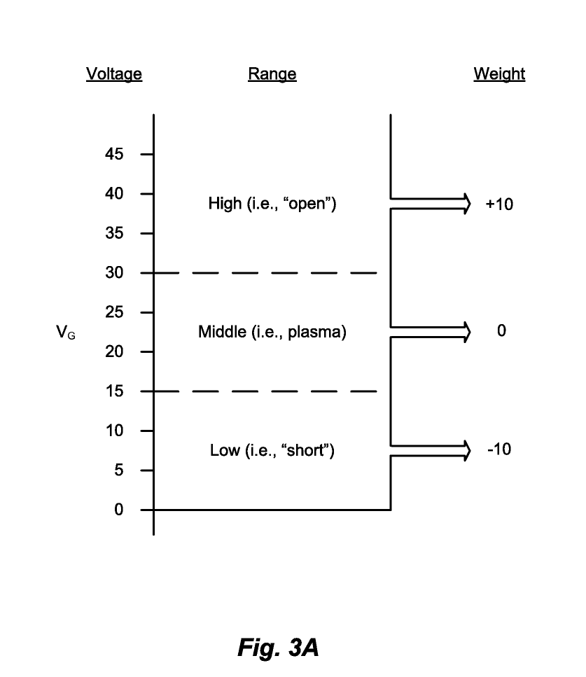

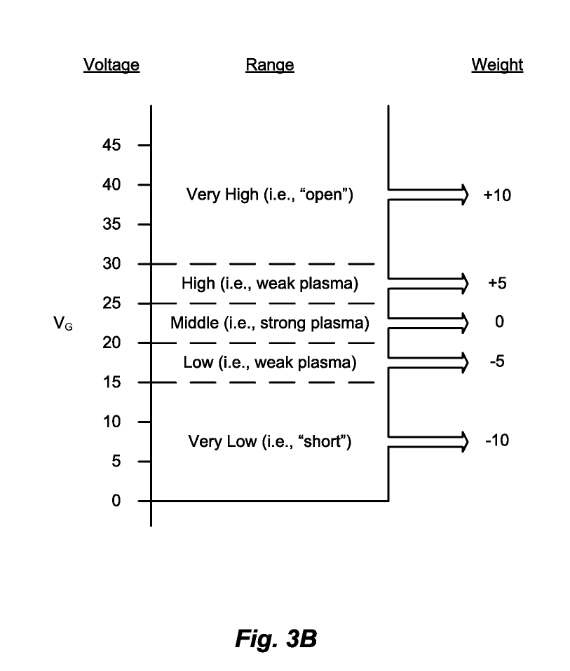

According to some exemplary implementations, ranges of spark gap voltages may be defined, wherein each measurement is determined to be within one of the ranges. For example, as shown in FIGS. 3A and 3B, spark gap voltages may be categorized into one of a plurality of ranges. Any number of ranges may be provided, and the upper and lower limits defining each range may be programmable. A middle range may be defined as the preferred range for occurrence of plasma events.

According to some exemplary implementations, as shown in FIG. 3A, a range of low voltages may correspond to a short state, in which the spark gap is too narrow to facilitate a plasma event. A range of middle voltages may correspond to an plasma state of the spark gap, in which the spark gap is properly sized to facilitate a plasma event. A range of high voltages may correspond to an open state of the spark gap, in which the spark gap is too wide to facilitate a plasma event.

According to some exemplary implementations, as shown in FIG. 3B, one or more ranges above and below the middle range may represent voltages in which plasma events may occur, but at a lesser strength and effectiveness. The middle range represents the voltage or voltages at which ideal conditions for a strong plasma event are present. At least one range may correspond to a low-voltage weak plasma state in the spark gap, in which a weak plasma event occurs at a lower-than-optimal voltage. At least one range may correspond to a high-voltage weak plasma state in the spark gap, in which a weak plasma event occurs at a higher-than-optimal voltage.

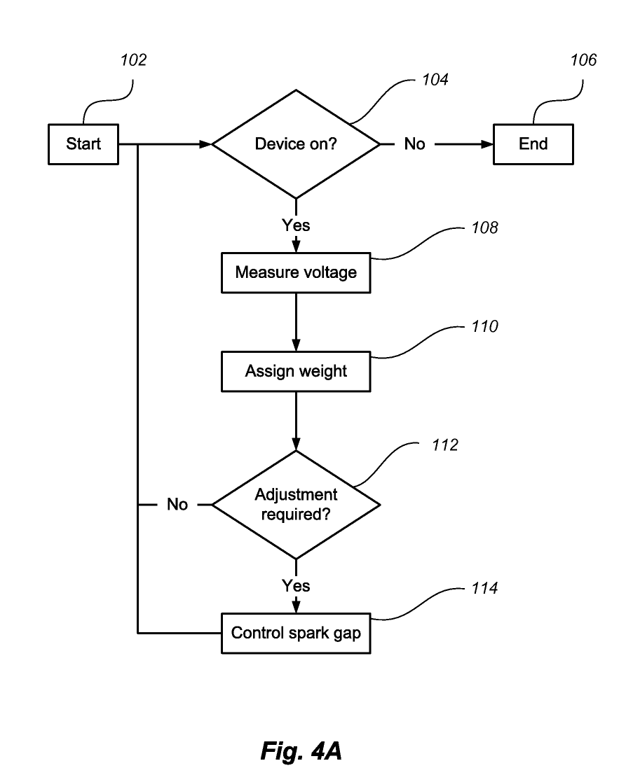

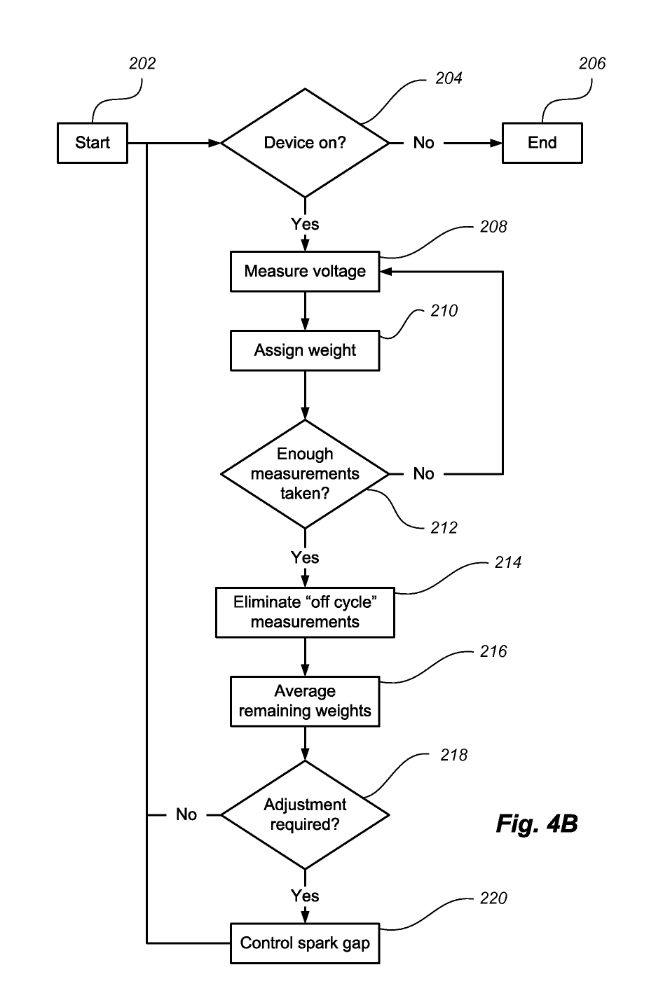

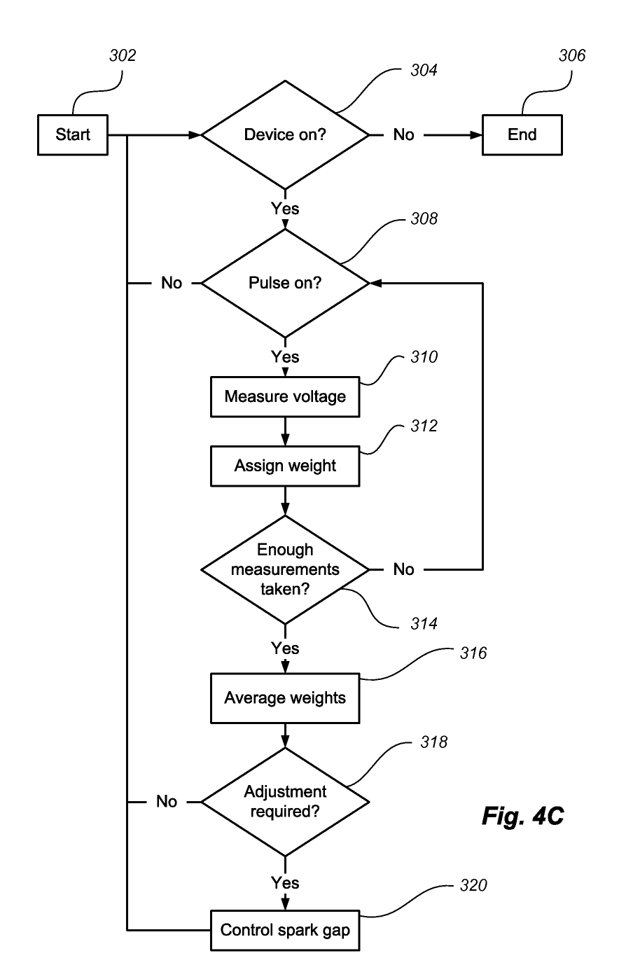

According to some exemplary implementations, as shown in FIG. 3A and 3B, a measurement of the spark gap voltage may be assigned a “weight parameter” according to the range corresponding to the measurement taken. The weight parameter may be roughly proportionate to or otherwise representative of the deviation of the measured voltage from a target voltage. For example, spark gap voltages measured in the middle range may be assigned a weight parameter of 0, meaning that no adjustment may be necessary. Spark gap voltages measured in the range(s) above the middle range may be assigned a positive value, and spark gap voltages measured in the range(s) above the middle range may be assigned a negative value. According to some exemplary implementations, a measurement taken may be used to calculate a parameter, as shown in FIGS. 4A, 4B, and 4C. Each weight parameter may be unique to its corresponding range.

According to some exemplary implementations, methods of measuring, processing, and responding to conditions in the spark gap are disclosed. As shown in FIG. 4A, a process may be initiated at operation 102. At operation 104, the EDM device may be determined to be in an “on” or “off” state, as provided by a user or operator. At operation 106, the process may end if the device is off At operation 108, a voltage of the spark gap is measured. At operation 110, the voltage measured is assigned a weight parameter according to programmed criteria. Assigning a weight parameter may be or include processing the voltage reading or applying an algorithm to the voltage reading for determining a response command. For example, assigning a weight parameter may be or include determining the difference between a measured voltage and a target voltage. At operation 112, adjustment, if any, may be determined according to a response command generated based on at least one of the weight parameter and the measured voltage. Assignment of a response command may be or include generating a protocol for adjusting or not adjusting the spark gap based on the weight parameter. If adjustment is not needed, then the process may return to operation 104. If adjustment is needed, then the spark gap may be controlled and adjusted according to the response command at operation 114. The process may cycle through one or more repetitions.

According to some exemplary implementations, a plurality of measurements taken may be combined to calculate a combination parameter, as shown in FIGS. 4B and 4C. Where control module 20 may take voltage measurements in periods less than or substantially less than a pulse period, a plurality of such measurements may represent conditions within a single pulse period or across a plurality of pulse periods.

As shown in FIG. 4B, a process may be initiated at operation 202, continued at operation 204, or optionally terminated at operation 206. At operation 208, a voltage of the spark gap is measured and assigned a weigh at operation 210. At operation 212, a determination may be made whether enough measurements have been taken. If not, more may be taken at operation 208. If so, then the measurements or weight parameters may be filtered at operation 214, whereby measurements or parameters taken during off-cycle or inactive states are eliminated. Accordingly, remaining parameters are provided as those not eliminated in operation 214. At operation 216, the remaining parameters are combined to provide a combination parameter. The combination parameter may be of a plurality of voltage measurements, a plurality of weight parameters respectively assigned to a plurality of voltage measurements, or any other value representing conditions in the spark gap. The combination parameter may be an average, a weighted average, or any other mathematical and statistical calculation for combining a plurality of data points. Response commands may be determined based on the combination parameter, and the spark gap may be managed accordingly at operation 220.

Those skilled in the art will recognize that ranges, calculations, and assigned values are merely symbolic representations for use by exemplary implementations of a system of the present disclosure; a variety of variations on the exemplary implementations expressly demonstrated herein may be within the scope of the present disclosure inasmuch as systems may be designed to accommodate such variations.

As shown in FIG. 4C, a process may be initiated at operation 302, continued at operation 304, or optionally terminated at operation 306. At operation 308, a determination is made whether a pulse is being provided (e.g., in an active state rather than an inactive state of a duty cycle). If a pulse is on, then the process proceeds to operation 310, at which a voltage of the spark gap is measured and assigned a weigh at operation 312. If a pulse is not on, then the process waits until the pulse returns. At operation 314, a determination may be made whether enough measurements have been taken. If not, the process may return to operation 308. If so, then at operation 316, weight parameters or measured voltages are combined to provide a combination parameter. Response commands may be determined based on the combination parameter, and the spark gap may be managed accordingly at operation 320.

According to some exemplary implementations, as shown in FIG. 4B and 4C, combination parameters may exclude values that are determined by control module 20 to correspond to inactive periods (i.e., periods in which there is no duty cycle). Because both switch control 24 and voltage sensor 90 are centrally operated by control module 20, the operation data of each may be used in concert. For example, measurements may be taken by voltage sensor 90 and annotated according to whether the measurement was taken while switch control 24 had caused switch 26 to be open. Accordingly, the calculation of a combination parameter would be based on the remaining voltage measurements or weight parameters. Such a determination and exclusion may also be made at the time voltage sensor 90 takes a measurement; control module 20 may selectively ignore measurements taken while switch 26 is open. Further, voltage sensor 90 may be configured to operate only when the switch control is known to have caused switch 26 to be closed, as shown in FIG. 4C.

According to some exemplary implementations, operation of motor control 30 may be based on the measurements and calculations of control module 20. For example, advancement or retraction of erosion electrode 66 may be effected based on at least one of the voltage measured, a weight parameter, or a combination parameter. Advancement or retraction of erosion electrode 66 may be in proportion to the amount of motion required to achieve an optimal size spark gap, as calculated by control module 20.

The process described above can be stored in a memory of a computer system as a set of instructions to be executed. In addition, the instructions to perform the processes described above could alternatively be stored on other forms of machine-readable media, including magnetic and optical disks and related media. For example the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

Spark Gap Control with a Direct-Coupled Piezo-Activated Configuration

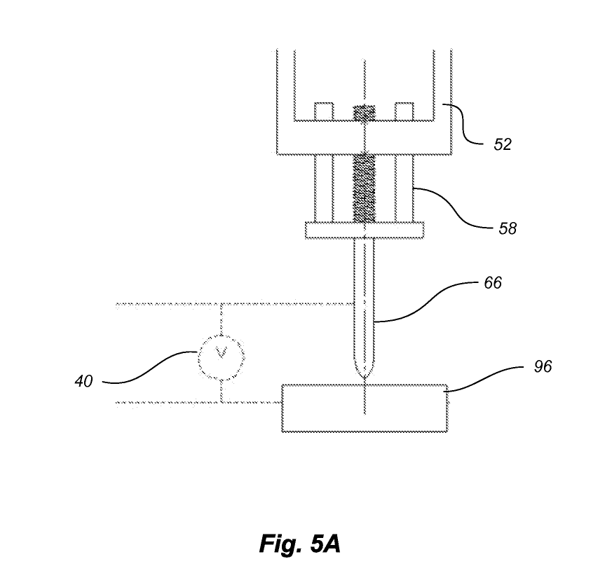

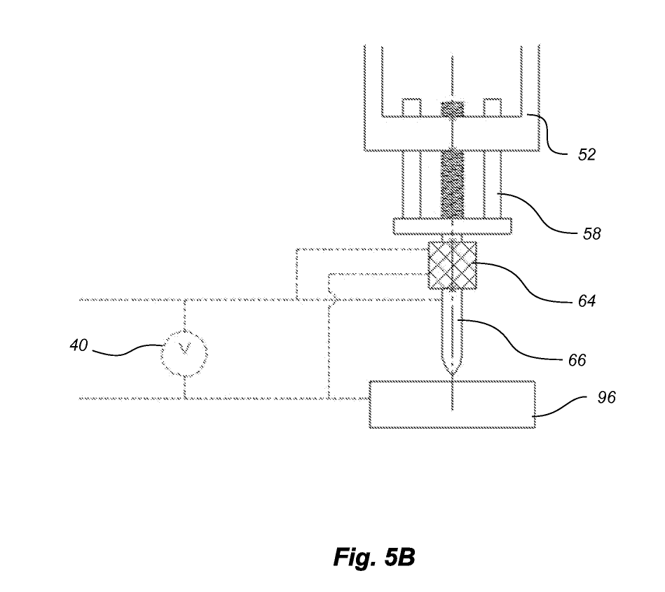

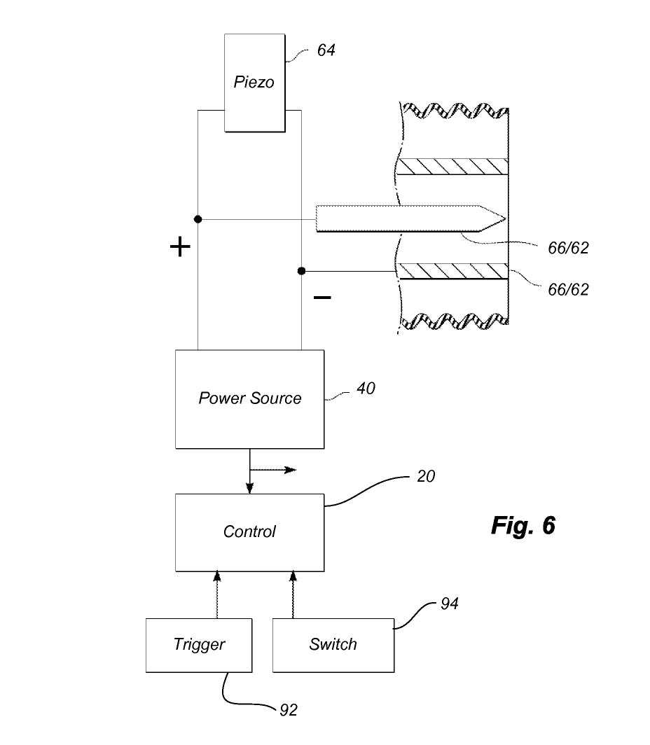

According to some exemplary implementations, control of the size of a spark gap may be rapidly and automatically managed by piezoelectric crystal 64 or other structure responsive to a voltage applied thereto, as shown in FIGS. 5B and 6. According to some exemplary implementations, erosion electrode 66 may be connected to driver housing 58, which may be slideably mounted on base 52 on suitable rails, for example. Motor 60 may advance or retract driver housing 58—and thereby erosion electrode 66—relative to a workpiece. Piezoelectric crystal 64 may be mounted between driver housing 58 and erosion electrode 66.

According to some exemplary implementations, piezoelectric crystal 64 may be direct coupled to erosion electrode 66 and ground electrode 62, such that the same DC pulse which causes the EDM erosion process also energizes piezoelectric crystal 64. Electrically, piezoelectric crystal 64 is connected in parallel with the spark gap, as shown in FIGS. 5B and 6. Assuming an open-circuit condition initially, the onset of a voltage pulse causes piezoelectric crystal 64 to extend erosion electrode 66 relative to at least one of base 52 and electrode driver housing 58.

FIG. 5B shows a schematic representation of an illustrative direct-coupled piezo-activated (“DCPA”) configuration of an EDM device, compared with an illustrative conventional EDM device, shown in FIG. 5A. Both systems illustrate workpiece 96, erosion electrode 66, and electrode driver housing 58. Both are connected to power source 40 which delivers DC pulses between workpiece 96 and erosion electrode 66. In both cases, electrode driver housing 58 may adjust the gap between workpiece 96 and erosion electrode 66 based on a variety of methods, including those disclosed herein. According to some exemplary implementations, the DCPA device has piezoelectric crystal 64 located between erosion electrode 66 and electrode driver housing 58

In both a DCPA device and the conventional device, the DC pulse on-time and off-time may be in the range of 50-1000 microseconds, for example. However, the response time (including measurement and action taken in response) of many active closed-loop control devices may be about 3 milliseconds or slower, which is insufficient to provide a desired response within the time period of each DC pulse, as disclosed herein. Hence in a conventional system, some pulses are supplied between erosion electrode 66 and workpiece 96 across a less than optimal spark gap size, and plasma does not occur or is inefficient in material removal.

In such cases, piezoelectric crystal 64 may provide more rapid response adjustments to manage the size of the spark gap and create more optimal conditions for frequent occurrence of plasma events. According to some exemplary implementations, upon each DC pulse, piezoelectric crystal 64 charges and expands, thus driving the electrode forward, until the DC pulse terminates and piezoelectric crystal 64 retracts. The response time of piezoelectric crystal 64 is typically comparable or faster than the DC pulse on and off times. Typically, piezo advance reaction times are of the order of 300 microseconds, and retract reaction times are in the range of 30 microseconds, both of which are compatible with typical EDM power source on-time and off-time. Thus, piezoelectric crystal 64 is able to adapt to the spark gap and make small adjustments to the gap in real-time during pulses, significantly improving the efficiency of material removal from the workpiece.

According to some exemplary implementations, motor 60 is activated by trigger 92 or proximity switch 94, inter alia. As erosion electrode 66 is brought forward toward workpiece 96, a charge is applied to erosion electrode 66. At sufficiently high voltages and sufficiently low spark gap sizes, a plasma event occurs, allowing a current to pass through the spark gap. The ensuing drop in voltage de-energies piezoelectric crystal 64 to withdraw the face of erosion electrode 66 away from workpiece 96. Since power source 40 has topped, the arc is extinguished. The arc had caused a plasma volume and when the arc is extinguished, this plasma collapses. It is this plasma collapse which causes a localized shock which knocks loose pieces of material from the workpiece. The loose material is quickly washed away by dielectric fluid. Since the arc is extinguished, the voltage rises by virtue of power source 40, erosion electrode 66 advances, and a new arc is initiated.

According to some exemplary implementations, a novel measurement and response system may be combined with a piezoelectric crystal configuration. For example, the novel measurement and response system may be provided and operated as disclosed herein wherein the actuation by the system is applied to driver housing 58. Piezoelectric crystal 64 may be provided as disclosed herein to operate in tandem with the novel measurement and response system.

Comparative Results from Experimental Usage

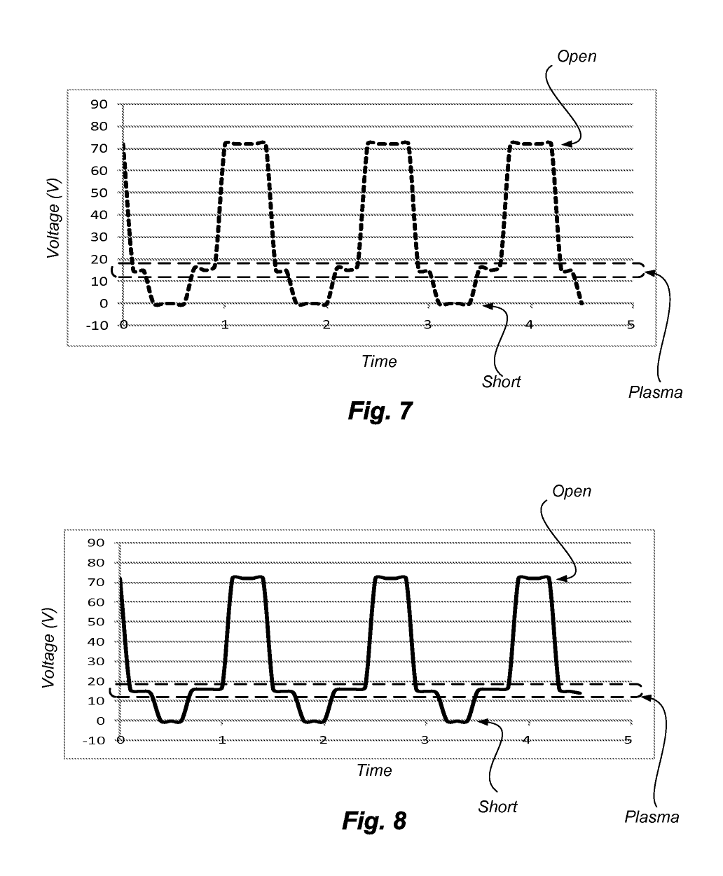

According to experimental data recorded, EDM processes were performed using (A) a traditional controller by Galil Motion Control, Inc.® (Rocklin, Calif.), (B) a piezoelectric crystal configuration, (C) a novel measurement and response system, and (D) a combination of a piezoelectric crystal and a novel measurement and response system. FIGS. 7, 8, and 9 show graphical representations of the data gathered. Comparisons were made on the basis of efficiency of erosion via plasma events as represented by time required to produce comparable erosions. FIGS. 7, 8, and 9 show the progress of electro-mechanical control in optimizing material removal rate. Each graph demonstrates the average voltage across the spark gap (y-axis) as a function of time (x-axis). The graph oscillates as a result of closed-loop spark gap control.

According to some exemplary implementations, a high frequency 50-70 volt DC square wave was applied to the electrode and fastener, with the fastener being the positive pole. Plasma occurred if the spark gap is correct, and at a voltage of approximately 14-18 volts. Simultaneously with the high-frequency pulse, a lower frequency oscillation occurs as the control system continuously adjusts the spark gap based on the average voltage measured. If the voltage feedback system is too coarse, the optimal electrode gap will be overshot consistently and a short will occur. Typical EDM machine tools are not capable of rapid response due in part to the mass of the positioning elements in a machine tool, so plasma briefly occurs as the spark gap oscillates between too large and too small, and plasma efficiency is low. Therefore typical EDM material removal rates are low.

FIG. 7 demonstrates data from operation of a traditional mechanism, and illustrates performance of spark gap control. Plasma, defined as activity in the region of about 14-18 volts (emphasized by the dashed rectangle), occurred only sporadically between open and short conditions, totaling about 10-15% of the total time.

FIG. 8 demonstrates data from operation of the same control system, but enhanced by a direct-coupled piezo-activated (DCPA) configuration. DCPA, correctly tuned, increased plasma activity to about 20-30% of the total time. A DCPA-enhanced system exhibited approximately 30% faster cycle times than without DCPA.

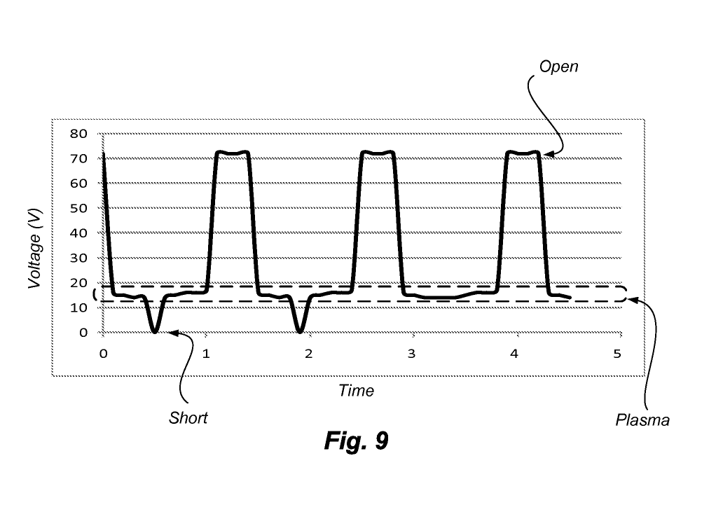

FIG. 9 demonstrates data from operation of novel measurement and response system. This system, without DCPA, avoids shorting the voltage on every pulse and results in plasma 60-70% of the time. The system depicted in FIG. 9 exhibits approximately 50% faster cycle times than a traditional mechanism depicted in FIG. 7.

The combination of the DCPA configuration and the novel measurement and response system provided an additional 10-15% improvement over the novel measurement and response system without DCPA (not shown in Figures).

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A method for controlling a spark gap, comprising:
measuring a voltage sample across a spark gap;
correlating the measured voltage sample with one of: an open state, a plasma state, and a short state of the spark gap;
assigning a weight parameter to the voltage sample, wherein each of the open state, the plasma state, and the short state have a unique weight parameter;
determining a response command based on the weight parameter;
causing a motor to control the spark gap based on the response command.

2. The method of claim 1, wherein:
a weight parameter of the open state corresponds to a response command to widen the spark gap;
a weight parameter of the plasma state corresponds to a response command to substantially maintain the spark gap; and
a weight parameter of the short state corresponds to a response command to narrow the spark gap.

3. The method of claim 1, wherein the plasma state occurs within one of a plurality of plasma voltage ranges.

4. The method of claim 3, wherein the plurality of plasma voltage ranges are contiguous.

5. The method of claim 3, wherein each of the plurality of plasma voltage ranges corresponds to a distinct weight parameter.

6. The method of claim 3, wherein the plurality of plasma voltage ranges comprise: a high-voltage weak plasma, a strong plasma, and a low-voltage weak plasma

7. The method of claim 1, wherein the voltage sample includes a plurality of measured voltages across the spark gap.

8. The method of claim 7, wherein determining a response command comprises:
eliminating measured voltages that correspond to measurements taken during an inactive period of a duty cycle to determine remaining parameters;
calculating a combination parameter as the average value of the remaining parameters, wherein the combination parameter corresponds to a response command; and
causing a motor to control the spark gap based on the response command.

9. A method for controlling a spark gap, comprising:
measuring a plurality of voltages across a spark gap, wherein the voltages are provided by a power source having a duty cycle with an active period and an inactive period;
assigning a weight parameter to each of the plurality of measured voltages;
calculating a combination parameter based on the measured plurality of voltages, wherein the combination parameter corresponds to a response command; and
causing a motor to control the spark gap based on the response command.

10. The method of claim 9, wherein causing the motor to control the spark gap results in an increased rate of plasma events.

11. The method of claim 9, wherein the weight parameter corresponds to one of: an open state, at least one plasma state, and a short state of the spark gap, each state having a corresponding weight parameter.

12. The method of claim 9, wherein the combination parameter is an average value of the weight parameters.

13. The method of claim 9, wherein the plurality of voltages are only measured during the active period of the duty cycle.

14. The method of claim 9, wherein calculating a combination parameter further comprises: eliminating weight parameters that correspond to voltages measured during the inactive period of the duty cycle, wherein the combination parameter is an average value of the parameters remaining after the eliminating step.

15. The method of claim 9, wherein measuring a plurality of voltages is performed at an interval having a measurement period not exceeding a pulse period of the duty cycle.

16. A control module, comprising:
a switch control configured to selectively open and close a switch connecting a power source to an erosion electrode of an EDM device;
a voltage sensor configured to sense a voltage in a spark gap;
a CPU configured to calculate a response command based on the voltage sensed in the spark gap; and
a motor control configured to cause a motor of the EDM device to selectively control the position of the erosion electrode according to the response command

17. The control module of claim 16, wherein the response command causes the spark gap to narrow, widen, or remain the same.

18. The control module of claim 16, wherein the response command is calculated based on a plurality of sensed voltage readings in the spark gap.

19. The control module of claim 16, wherein the motor is configured to controllably position the erosion electrode relative to the workpiece.

20. The control module of claim 16, wherein the control module is connected to the EDM device via an umbilical.

21. An EDM device, comprising:
a base;
a driver housing;
a motor configured to controllably position the driver housing relative to the base;
an erosion electrode connected to the driver housing by a piezoelectric crystal disposed between the erosion electrode and the driver housing;
wherein the EDM device is electrically connected to a power source configured to selectively provide a voltage across a spark gap;
wherein the piezoelectric crystal is electrically connected to the power source in parallel with the spark gap and is configured to advance or retract the erosion electrode in response to the voltage from the power source.

22. The EDM device of claim 21, wherein the piezoelectric crystal is configured to advance the erosion electrode toward the workpiece in response to an increase in the voltage from the power source.

23. The EDM device of claim 21, wherein the piezoelectric crystal is configured to retract the erosion electrode away from the workpiece in response to a drop in the voltage from the power source.

24. The EDM device of claim 21, wherein the motor is configured to selectively control the spark gap according to a response command based on a voltage sensed in the spark gap.

25. The EDM device of claim 21, wherein the EDM device is a hand-held unit.

26. The EDM device of claim 21, wherein the EDM device is connected to a control module via an umbilical.

27. The EDM device of claim 26, wherein the control module comprises:
a switch control configured to selectively open and close a switch connecting the power source to the erosion electrode of the EDM device;
a voltage sensor configured to sense the voltage in the spark gap;
a CPU configured to calculate a response command based on the voltage sensed in the spark gap; and
a motor control configured to cause the motor of the EDM device to selectively control the position of the erosion electrode according to the response command.
